(19) United States
(12) Patent Application Publication
(10) Pub. No.: US 2026/0162038 A1
(43) Pub. Date: Jun. 11, 2026

(54) ESTIMATING COMPLETION TIMES OF TRANSACTIONS IN APPLICATIONS LEVERAGING LARGE LANGUAGE MODELS

(71) Applicant: SAP SE, Walldorf (DE)

(72) Inventors: Wei Liang Lim, Singapore (SG); Junxiang Jia, Singapore (SG); Hu Soon Tan, Singapore (SG); Zhen Shu, Singapore (SG); Kunnan Hong, Singapore (SG); Alexy Xena Hackmann, Singapore (SG)

(21) Appl. No.: 18/969,353

(22) Filed: Dec. 5, 2024

(51) Int. Cl. G06Q 10/0633

(52) U.S. Cl. CPC G06Q 10/0633

(57) ABSTRACT

Methods, systems, and computer-readable storage media for receiving a set of tokens representative of user input to a LLM-based application that executes transactions with a LLM, determining a number of target input tokens based on an input ratio, predicting a number of output tokens of the LLM using an output token estimation model, selecting a completion time estimation model from a set of completion time estimation models based on a set of parameters associated with the user input, generating an estimated completion time by processing the number of output tokens through the completion time estimation model, and displaying the estimated completion time in a user interface.

### BACKGROUND

Enterprises execute a multitude of workflows, each including a series of underlying tasks, in order to perform enterprise operations. Execution of workflows can be performed across multiple data centers, systems, and platforms. For example, workflows can be executed within and/or across an enterprise resource planning (ERP) system, a human capital management (HCM) system, and a customer relationship management (CRM) system, to name a few. Enterprises continuously seek to improve and gain efficiencies in their operations. To this end, enterprises integrate systems in the domain of so-called intelligent enterprise, which can employ artificial intelligence (AI) that can include, for example, machine learning (ML) models. For example, AI can be used for data analytics and/or automating tasks in support of enterprise operations. AI, however, presents technical hurdles and risks that need to be mitigated in use by enterprises.

### SUMMARY

Implementations of the present disclosure are directed to estimating completion times of transactions in applications that leverage large language models (LLMs). More particularly, implementations of the present disclosure are directed to a completion time estimation system that uses regression models to estimate a number of output tokens of a LLM based on a number of input tokens to the LLM and to estimate a completion time based on the number of output tokens. An estimated completion time can be provided to a user as, for example, a visualization within a user interface.

In some implementations, actions include receiving a set of tokens representative of user input to a LLM-based application that executes transactions with a LLM, determining a number of target input tokens based on an input ratio, predicting a number of output tokens of the LLM using an output token estimation model, selecting a completion time estimation model from a set of completion time estimation models based on a set of parameters associated with the user input, generating an estimated completion time by processing the number of output tokens through the completion time estimation model, and displaying the estimated completion time in a user interface (UI). Other implementations of this aspect include corresponding systems, apparatus, and computer programs, configured to perform the actions of the methods, encoded on computer storage devices.

These and other implementations can each optionally include one or more of the following features: the output token estimation model is specific to the LLM and is selected from a set of output token estimation models; the set of completion time estimation models is specific to the LLM and is selected from a plurality of sets of completion time estimation models; the set of completion time estimation models is further specific to a server that the LLM is executed on; the completion time estimation model is selected from the set of completion time estimation models based on an hour and a day indicated in the set of parameters; the estimated completion time includes a lower bound estimated completion time and an upper bound estimated completion time; and displaying the estimated completion time in a UI comprises displaying a visualization that graphically represents the estimated completion time and is animated to indicate a decreasing estimated completion time as time tolls since the user input was received.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for estimating completion times in accordance with implementations of the present disclosure.

FIG. 3 depicts example representations of completion time estimation models in accordance with implementations of the present disclosure.

FIG. 4 depicts a graph illustrating experimental results for estimating completion times in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to estimating completion times of transactions in applications that leverage large language models (LLMs). More particularly, implementations of the present disclosure are directed to a completion time estimation system that uses regression models to estimate a number of output tokens of a LLM based on a number of input tokens to the LLM and to estimate a completion time based on the number of output tokens. An estimated completion time can be provided to a user as, for example, a visualization within a user interface.

Implementations can include actions of receiving a set of tokens representative of user input to a LLM-based application that executes transactions with a LLM, determining a number of target input tokens based on an input ratio, predicting a number of output tokens of the LLM using an output token estimation model, selecting a completion time estimation model from a set of completion time estimation models based on a set of parameters associated with the user input, generating an estimated completion time by processing the number of output tokens through the completion time estimation model, and displaying the estimated completion time in a user interface (UI).

To provide further context for implementations of the present disclosure, in the field of artificial intelligence (AI), generative AI (GAI) has recently seen an explosion in popularity. GAI can be described as including foundation models that generate content based on training data. For example, foundation models can include LLMs, which are a form of GAI that can be used to generate text and perform other functions for a variety of use cases. The increasing power and popularity of GAI has seen enterprises seeking avenues to leverage GAI in improving enterprise operations. However, integrating GAI into enterprise platforms is a non-trivial task. For example, GAI can present various technical challenges and can have disadvantages that have to be managed. The technical challenges and risks did not exist in the pre-GAI world.

More particularly, LLMs hold immense potential in enhancing enterprise operations. For example, integration of LLMs into enterprise-level applications enable the natural language reasoning and generation capabilities of LLMs to be utilized for various tasks (e.g., chatbots, question-answering over a set of documents, writing assistance). However, and among various concerns with LLM-based applications, completion time can be problematic, particularly for enterprise-level applications. Here, completion time can include the time that it takes for a LLM to process input (referred to as prompts) and return output. In some instances, the completion time can significantly vary depending on a multitude of factors. In some instances, the completion time can be relatively long. This variation in completion times including increased latency can be particularly problematic for enterprises, whose operations can be time-sensitive and expect some level of consistency. Additionally, the steep resource requirements and/or proprietary nature of many LLMs necessitate that LLMs are hosted on external inference servers. This means that the performance of LLMs can vary depending on the network condition and the workload on the server, introducing a further degree of unpredictability.

Given these challenges, expectations of users of LLM-based applications need to be managed in terms of response generation times for an enhanced and seamless user experience. One such way to achieve this would be to provide realistic completion time estimates to users.

In view of the above context, implementations of the present disclosure provide approaches to estimating completion times for responses in enterprise-level, LLM-based applications. More particularly, implementations of the present disclosure enable estimation of a completion time of a given request for a LLM-based application with constrained output. As described in further detail herein, implementations of the present disclosure provide a multi-stage approach. In a first stage, an application-specific relationship between input tokens (e.g., of prompts to a LLM) and output tokens (e.g., of responses from the LLM) is used to provide an estimated number of output tokens. In a second stage, an application-agnostic relationship between output tokens and completion times is used to provide an estimated completion time based on the estimated number of output tokens. In some examples, the estimated completion time is returned to a user, while the LLM is processing a prompt that is based on user input from the user.

Implementations of the present disclosure are described in further detail herein with reference to an example domain for an enterprise-level application and an example use case within the example domain. The example domain includes human capital management (HCM) and the example use case includes mitigating bias. In the example domain, an enterprise can execute operations related to HCM using, for example, one or more HCM applications that can leverage one or more LLMs (i.e., LLM-based applications). It can be noted that HCM is a particularly vulnerable domain for bias-related concerns, because bias in the LLMs could manifest as unfair hiring practices, stifle diversity in the organization, and/or trigger ethical and/or legal repercussions. In some instances, bias in output of the LLM can be seeded in bias provided in user input to the LLM. To mitigate bias, the LLM-based application can include a text analyzer that leverages a LLM to detect and mitigate bias in user input to the LLM-based application.

In the example domain of HCM and the example use case of bias, bias of a LLM can be illustrated by prompting the LLM to perform some task. An example task can include matching resumes (also referred to as curriculum vitae (CVs)) to job descriptions (JDs). This task can generally be described as evaluating candidates (represented in the CVs) as potential hires for jobs (represented in the JDs). In some examples, a prompt can ask an LLM to provide a matching score that represents a degree to which a CV matches a JD, the matching score being on a pre-defined scale (e.g., 0-1). In this example, a CV is used and a first comparison and a second comparison are made with a JD using a LLM.

In the first comparison, the CV includes a male's name and, in the second comparison, the CV includes a female's name. All other details of the CV remain the same. In the first comparison, the LLM returns a first score (e.g., 0.85) and, in the second comparison, the LLM returns a second score (e.g., 0.71), the first score being greater than the second score. Here, bias of the LLM is highlighted in that, when the CV used a male's name the matching score is higher than when the CV used a female's name, with all other details being the same. To avoid this, a text analyzer of the LLM-based application can leverage a LLM to detect text that can inadvertently introduce bias and recommend changes to the text to mitigate bias. For example, and continuing with the non-limiting example above, the text analyzer can leverage a LLM to revise JDs and/or CVs that are to be compared to eliminate content that could potentially seed bias in downstream LLM results.

Further details of the example domain and the example use case are discussed in commonly assigned U.S. application Ser. No. 18/644,267, filed on Apr. 24, 2024, and entitled Mitigating Bias in Large Language Models, the disclosure of which is expressly incorporated herein by reference in the entirety for all purposes.

While implementations of the present disclosure are described in further detail herein with reference to the example domain of HCM and the example use case of bias, it is contemplated that implementations of the present disclosure can be realized in any appropriate domain and/or any appropriate use case.

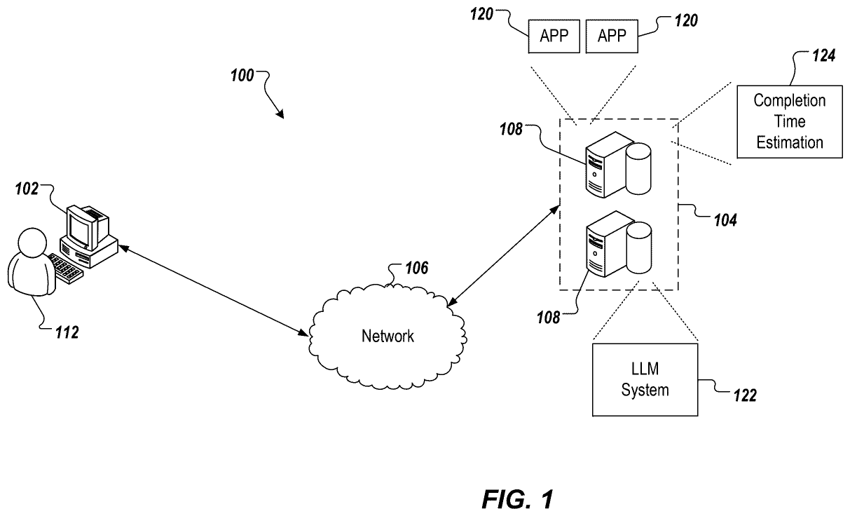

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host one or more LLM-based applications 120 that are provisioned to support enterprise-level operations. In some examples, the server system 104 hosts a LLM system 122. For example, the LLM system 122 can be provided by a third-party (e.g., ChatGPT provided by OpenAI). In some examples, each of the LLM-based applications 120 queries (e.g., prompts) the LLM system 122, which returns a response that is responsive to the query. This process of prompting and returning a response can be referred to as a transaction. In some examples, and as described in further detail herein, the server system 104 hosts a completion time estimation system 124 that provides completion time estimates for transactions with the LLM system 122 (e.g., time estimates for the LLM system 122 to provide responses to queries submitted by the LLM-based applications 120).

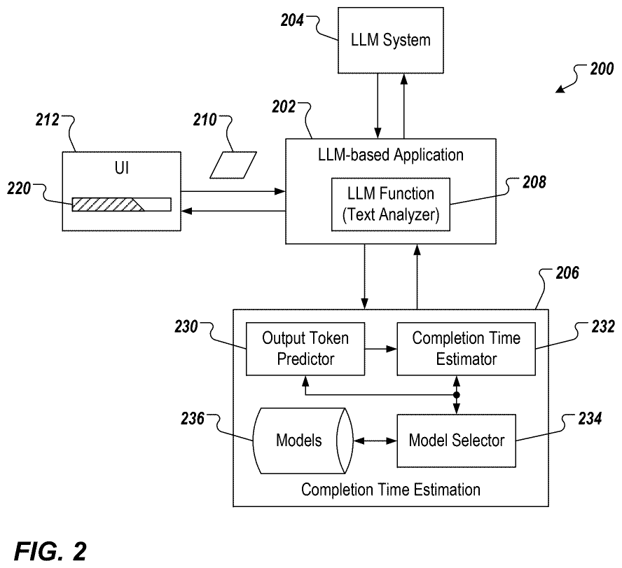

FIG. 2 depicts an example conceptual architecture 200 in accordance with implementations of the present disclosure. In the depicted example, the conceptual architecture 200 includes a LLM-based application 202, an LLM system 204 (e.g., ChatGPT), and a completion time estimation system 206. In some examples, the LLM-based application 202 provides enterprise-level functionality that leverages the LLM system 204. For example, the LLM-based application 202 includes a LLM function module 208 that processes user input 210 and uses the user input to prompt the LLM system 204. In some examples, a user (e.g., the user 112 of FIG. 1) can provide the user input 210 to the LLM-based application 202 through a user interface (UI) 212 (e.g., displayed on the client device 102 of FIG. 1). The user input 210 can include any appropriate user input (e.g., text, computer-readable file, image, audio).

In the example of FIG. 2, the completion time estimation system 206 includes an output token predictor 230, a completion time estimator 232, a model selector 234, and a model repository 236. As described in further detail herein, the completion time estimation system 206 provides an estimated completion time (T_{comp}) for the LLM system 204 to process a prompt that is generated based on the user input 210 and return a response (collectively, a transaction).

For purposes of illustration, non-limiting examples are discussed in the context of the example domain and the example use case introduced above. For example, the user input 210 can include a JD that is provided in a computer-readable file. An example portion of a JD for a Community Health Worker position can be provided as:
Job Title: Community Health Worker
Company: HealthHub
Location: On-site
Position Description:
Welcome to one of the toughest and most fulfilling ways to help people, including yourself. We offer the latest tools, most intensive training program in the industry and nearly limitless opportunities for advancement. Join us and start doing your life's best work.
Positions are responsible for providing clinical and medical management services, including case management, health assessments, interventions, and discharge planning. May identify, coordinate or provide appropriate levels of care under the direct supervision of an RN or MD. This function does not include Health Coach, Health Educator and Health Advocate roles that do not require an RN. Those roles are found in the Wellness Coach Management function.
Primary Responsibilities:
Engage members either face to face or over the phone to have a discussion about their health . . . .

### Example Portion of Job Description

In some examples, the LLM function module 208 of the LLM-based application 202 prompts the LLM system 204 to detect potential bias in the user input 210 and recommend revisions to mitigate the bias within the user input 210. For example, the LLM function 208 can include a prompt generator that generates a bias-detection prompt using a prompt template. An example bias-detection prompt can be provided as:
You are a strict bias detection and content moderation expert, with 20 years of experience in HR.
No inappropriate, problematic or biased content can get past you.
Your task is as follows:
STEP 1. Read the article provided to learn more about types of problematic text.
STEP 2. Read the user input provided. Keep the text open and keep referring to it as needed.
STEP 3. BASED ON THE SURROUNDING SENTENCE STRUCTURE IN THE INPUT TEXT, identify all problematic words/phrases in the input text. Each problematic word/phrase should ONLY contain ONE TYPE of problematic text type. You should identify the ENTIRE word, phrase or sentence fragment that NEEDS to be changed to MAINTAIN correct grammatical structure.
STEP 4. BASED ON THE SURROUNDING SENTENCE STRUCTURE IN THE INPUT TEXT, either re-write the problematic word or phrase that was detected in STEP 3, OR return an empty string if the word or phrase can be removed. Ensure that it can directly replace the problematic text in the original sentence, without any grammatical errors arising.
Besides obvious problematic speech, please detect problematic speech that is not obvious, or that is disguised as a form of humour, a metaphor, or in a negated sentence etc.
Here is the article:
###
Examples of harmful content (not limiting, be thorough in your detection):
1. Discriminatory Language: This includes any language that discriminates based on age, race, gender, sexual orientation, religion, or disability.
2. Gender-Biased Language: Using gender-specific pronouns or terms can be problematic. Also, specifying a gender or using certain words can trigger unconscious bias. Be aware of the nuances in the words used.
3. Ableist Language: This includes language that discriminates against people with disabilities.
4. Classist Language: This includes language that discriminates based on social class.
5. Exclusionary Language: Any language that implies only certain groups of people are welcome.
6. Offensive or Derogatory Language: Using offensive or derogatory terms or phrases is harmful and inappropriate.
7. Heteronormative Language: Language that assumes everyone is heterosexual.
8. Racist Language: Any language that discriminates or stereotypes based on race or ethnicity.
9. Sexist Language: This includes language that discriminates or stereotypes based on gender.
10. Body Shaming Language: Any language that discriminates based on body size or appearance.
11. Overemphasis on Physical Abilities: Do not restrict or limit a person based on physical abilities, unless absolutely necessary.
12. Hate speech: Hate and fairness-related harms refer to any content that attacks or uses pejorative or discriminatory language with reference to a person or Identity groups on the basis of certain differentiating attributes of these groups including but not limited to race, ethnicity, nationality, gender identity groups and expression, sexual orientation, religion, immigration status, ability status, personal appearance and body size. Fairness is concerned with ensuring that AI systems treat all groups of people equitably without contributing to existing societal inequities. Similar to hate speech, fairness-related harms hinge upon disparate treatment of Identity groups.
13. Sexual: Sexual describes language related to anatomical organs and genitals, romantic relationships, acts portrayed in erotic or affectionate terms, pregnancy, physical sexual acts, including those portrayed as an assault or a forced sexual violent act against one's will, prostitution, pornography and abuse.
14. Violence: Violence describes language related to physical actions intended to hurt, injure, damage, or kill someone or something; describes weapons, guns and related entities, such as manufactures, associations, legislation, etc.
15. Self-harm describes language related to physical actions intended to purposely hurt, injure, damage one's body or kill oneself.

```
###
Here is the user input:
<START USER INPUT>
{user_input}
<END USER INPUT>
For the response generated, you should output a SINGLE JSON as your response.
Ensure that the JSON generated follows strictly the JSON_SCHEMA as defined
below:
If there is no problematic text detected, return an empty list for ‘flagged_content’. Do
NOT generate any other text outside of the JSON.
‘flagged_content_schema = {{
  “type”: “object”,
  “properties”: {{
    “flagged_content”: {{
      “type”: “array”,
      “items”: {{
        “type”: “object”,
        “properties”: {{
          “problematic_text_type”: {{“type”: “string”}},
          “problematic_word_or_phrase”: {{“type”: “string”}},
          “corrected_word_or_phrase”: {{“type”: “string”}},
          “problematic_text_explanation”: {{“type”: “string”}}
        }},
        “additionalProperties”: False,
        “required”: [
          “problematic_text_type”,
          “corrected_word_or_phrase”,
          “problematic_word_or_phrase”,
          “problematic_text_explanation”
        ],
      }},
    }}
  }},
  “additionalProperties”: False,
  “required”: [“flagged_content”],
}}’
```

### Example Bias-Detection Prompt

In some examples, a prompt module of the LLM function module 208 prompts the LLM system 204 (e.g., by making a call to the LLM system 204 through an application programming interface (API)), which processes the bias-detection prompt and returns a response. An example response can be provided as:

```
{
  “biases”: [
    {
      “bias_type”: “gender_bias”,
      “biased_text”: “man”,
      “corrected_text”: “individual”
    },
    {
      “bias_type”: “gender_bias”,
      “biased_text”: “he”,
      “corrected_text”: “they”
    },
    {
      “bias_type”: “gender_bias”,
      “biased_text”: “dominant figure”,
      “corrected_text”: “effective leader”
    },
    {
      “bias_type”: “gender_bias”,
      “biased_text”: “While we do not offer maternity leave”,
      “corrected_text”: “While we do not offer parental leave”
    },
```

### Example Output in JSON

In accordance with implementations of the present disclosure, and as described in further detail herein, the completion time estimation system 206 provides an estimated completion time that is based on the user input 210. For example, and in response to a transaction for prompting the LLM system 204, the LLM-based application 202 provides a request for an estimated completion time to the completion time estimation system 206. In some examples, the request can include an identifier that uniquely identifies the LLM of the LLM system 204 that is being prompted and a number of tokens in the prompt to the LLM system 204 and/or the prompt to the LLM system 204.

In some implementations, and in response to the request, the completion time estimation system 206 provides an estimated completion time. The estimated completion time is provided to the UI 212 for presentation to the user (e.g., by the completion time estimation system 206, by the LLM-based application 202). For example, a visualization 220 can be provided, which graphically represents the completion time. In some examples, the visualization 220 can be animated to indicate a decreasing estimated completion time as time tolls since the user input 210 was received (e.g., by the LLM-based application 202).

In further detail, in a first stage (application-specific stage), the completion time estimation system 206 selects an output token estimation model from a set of output token estimation models (e.g., {M_{out_tok,1}, . . . , M_{out_tok,p}}). For example, the model selector 234 selects an output token estimation model from the model repository 236 based on the LLM identified in the request, discussed above. In some examples, each output token estimation model is specific to a LLM that is being prompted. Each output token estimation model (M_{out_tok,i}) is used to provide an estimated output token count (N_{out_tok,i}), which represents an estimate of a number of tokens that will be in the output (response) returned by the respective LLM. In some examples, the output token estimation model models a relationship between the number of output tokens returned by the respective LLM system and a number of input tokens (N_{inp_tok}), which represents a number of tokens of the input (prompt) to the LLM system 204. In some examples, each token is provided as a string of characters (e.g., a word). In some examples, the number of input tokens (N_{inp_tok}) can be determined using a token counting tool (e.g., tiktoken provided by OpenAI).

In some examples, each output token estimation model is provided based on empirical data representative of historical transactions processed by the respective LLM. In some examples, historical transactions can be represented in tuples, each tuple including a prompt-response pair. Here, a prompt-response pair includes a number of tokens provided in a prompt (a number of input tokens) and a number of tokens returned in a response (a number of output tokens). In some examples, responses of the LLM can be constrained. For example, responses of the LLM can be constrained to be provided in a structured format, such as JSON.

In some implementations, each output token estimation model is provided as a linear regression model, which can be represented as:

$${N}_{out\_tok} = w \times {N}_{inp\_tok \_targ} + b \qquad ( 1 )$$

where N_{inp_tok_targ} represents a number of target tokens in the input (prompt). In some examples, a target token is a token that is expected to affect the output (response) of the LLM more than other tokens in the input. That is, some tokens will be more relevant to the task that the LLM is being put to through the response, and such tokens are referred to as target tokens. As a non-limiting illustration, the example domain and the example use case can be referenced, in which target tokens include tokens representative of bias. For example, the tokens [man], [he], [dominant figure], and [While we do not offer maternity leave] that are included in a JD as part of a prompt, would be target tokens, while other tokens (e.g., [Job Title], [Location], [Position Description]) are not target tokens.

Determining the number of target tokens in the input for a given task (e.g., correcting bias) is challenging. One approach would be to use natural language processing (NLP) models to process the input and estimate a number of target tokens. However, utilizing such NLP models is impractical, because the time taken for a NLP model to estimate the number of target tokens itself introduces latency. For example, by the time the NLP model returns the number of target tokens, the LLM can have already provide the response to the input. This obviates the purpose of providing estimated completion times.

In view of this, an input ratio parameter can be used to estimate the number of target tokens based on the number of input tokens. For example:

$${N}_{inp\_tok \_targ} = {r}_{inp} \times {N}_{inp\_tok} \qquad ( 2 )$$

In some examples, the input ratio is provided as a percentage estimate (e.g., 0.3 indicating that 30% of the input tokens are estimated to be target tokens). In some examples, the input ratio is determined based on historical data from user input. Accordingly, the number of target tokens of the input can be processed using Equation 1 to determine the number of output tokens (N_{out_tok}) expected to be in the response returned from the respective LLM.

In a second stage (application-agnostic stage), the completion time estimation system 206 selects a completion time estimation model from sets of completion time estimation models. For example, the model selector 234 selects a completion time estimation model from the model repository 236 based on the LLM and a set of time parameters identified in the request, discussed above. In some examples, each completion time estimation model is specific to a LLM that is being prompted and is specific to a time and a day represented in the set of time parameters.

In accordance with implementations of the present disclosure, each completion time estimation model corresponds to a day of the week and an hour during the day. Differentiating the completion time estimation models by day and hour accounts for the observation that completion times fluctuate from hour to hour and day to day given the same number of output tokens. For example, completion times for prompts executed at 13:00 on a weekday can differ widely from completion times for prompts executed at 13:00 on a weekend (e.g., LLMs and servers hosting LLMs have lower workloads on weekends). As such, each LLM is associated with a set of completion time estimation models. For example, the set of completion time estimation models can be provided as:

$${\{ {M}_{{comp}_{-} t , 1 , 1} , … , {M}_{{comp}_{-} t , 24 , 7} \}}_{1} , … , {\{ {M}_{{comp}_{-} t , 1 , 1} , … , {M}_{{comp}_{-} t , 24 , 7} \}}_{p}$$

Here, each set of completion time estimation models corresponds to a LLM and each completion time estimation model in a set of completion time estimation models corresponds to a time (h) and a day (d). In some examples, the time represents an hour in a set of hours [1, . . . , 24]. For example, hour 1 represents 00:00 (midnight) to 00:59, hour 2 represents 01:00 to 01:59, hour 3 represents 02:00 to 02:59, and so on, with hour 24 representing 23:00 to 23:59. In some examples, the day represents a day in a set of days. For example, day 1 represents Monday, day 2 represents Tuesday, and so on, with day 7 representing Sunday. As such, a set of time parameters [h, d] represents the h^{th} hour and the d^{th} day.

In some implementations, each completion time estimation model is provided as a linear regression model, which can be represented as:

$${T}_{comp , h , d} = {w}_{h , d} \times {N}_{out\_tok} + {b}_{h , d} \qquad ( 3 )$$

where T_{comp,h,d} is the estimated completion time and w and b are parameters determined for the hour h and the day d. In some examples, the hour h and the day d are determined from a timestamp that is received with the request, discussed above (e.g., the request to the completion time estimation system 206).

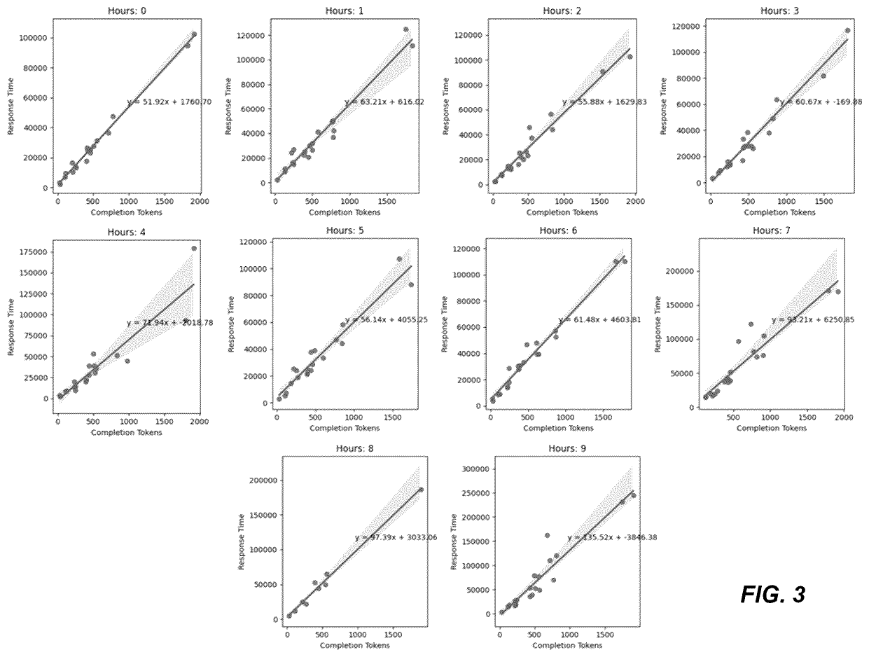

FIG. 3 depicts example representations of completion time estimation models in accordance with implementations of the present disclosure.

In some implementations, the data used to train the completion time estimation modes (e.g., the parameters w and b) can be generated by (1) making periodic LLM calls over the course of a week using different inputs and recording the completion times and numbers of output tokens, and/or (2) logging completion times and numbers of output tokens during regular production usage of the LLM (e.g., enterprises prompting the LLM during execution of enterprise operations).

In some implementations, each set of completion time estimation models is specific to a LLM and a server that the LLM is executed on. For example, a LLM can be executed on multiple servers to enable load balancing of requests, availability, and the like. Each server has its own characteristics with respect to latency in handling requests. In view of this, the completion time estimation model can be selected (from the model repository 236) based on the LLM, the set of time parameters, and a server identifier that uniquely identifies the server that is executing the LLM. For example, the model selector 234 selects a completion time estimation model from the model repository 236 based on the LLM, the set of time parameters, and a server identifier included in the request (e.g., the request to the completion time estimation system 206), discussed above.

In accordance with implementations of the present disclosure, the estimated completion time is determined from the completion time estimation model using the number of output tokens (N_{out_tok}) as input (e.g., determined using Equation 1, above). As described herein, the estimated completion time is provided to the UI 212 for presentation to the user (e.g., by the completion time estimation system 206, by the LLM-based application 202).

In some implementations, instead of providing the estimated completion time as a single value (e.g., 10 s), the estimated completion time can be provided as a range between a lower bound and an upper bound (e.g., [7 s, 12 s]). In this manner, inherent invariability in LLMs can be accounted for.

In further detail, in the first stage, a lower bound (l) number of output tokens and an upper bound (μ) number of input tokens can be provided using the following example (LLM-specific) output token estimation models:

$${N}_{out\_tok \_l} = w \times {N}_{inp\_tok \_targ \_l} + b \qquad ( 4 )$$

$${N}_{out\_tok \_u} = w \times {N}_{inp\_tok \_targ \_u} + b \qquad ( 5 )$$

Here, a lower bound number of target input tokens (N_{inp_tok_targ_l}) and an upper bound number of target input tokens (N_{inp_tok_targ_u}) are used to determine the respective lower and upper bound numbers of output tokens.

As discussed above, an input ratio parameter can be used to estimate the number of target tokens based on the number of input tokens. For determining the lower bound and the upper bound numbers of target input tokens, a lower bound input ratio and an upper bound input ratio are respectively used. For example:

$${N}_{inp\_tok \_targ \_l} = {r}_{inp\_l} \times {N}_{inp\_tok} \qquad ( 6 )$$

$${N}_{inp\_tok \_targ \_u} = {r}_{inp\_u} \times {N}_{inp\_tok} \qquad ( 7 )$$

In some examples, r_{inp_l} is less than r_{inp_u}, (e.g., r_{inp_l}=0.25, r_{inp_u}=0.35).

In the second stage, the lower bound number of output tokens (N_{out_tok_l}) and the upper bound number of output tokens (N_{out_tok_u}) are each processed through the (selected) completion time estimation model to respectively provide the lower bound estimated completion time (T_{comp,h,d_l}) and the upper bound estimated completion time (T_{comp,h,d_u}). In some implementations, the estimated completion time is returned as the lower bound estimated completion time and the upper bound estimated completion time, collectively.

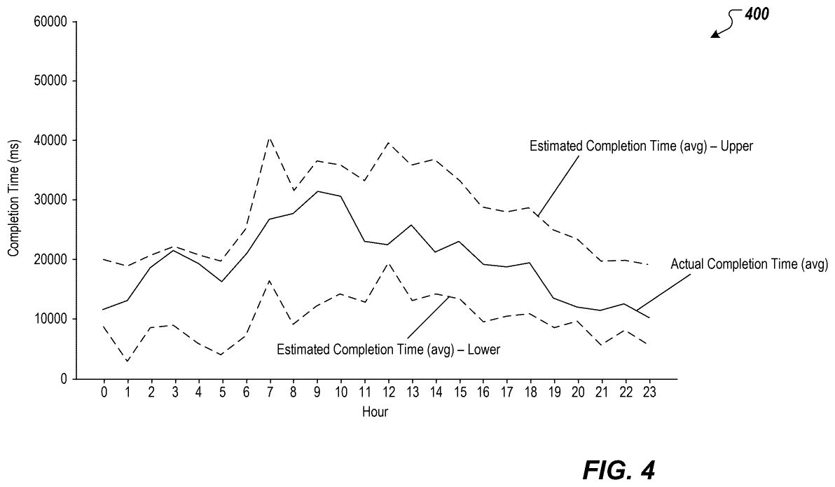

FIG. 4 depicts a graph 400 illustrating experimental results for estimating completion times in accordance with implementations of the present disclosure. To provide the experimental results of the graph 400, an evaluation was performed on an unseen test set of 1700 data points. The experimental results show that the range of estimated completion times accurately captures 79% of the actual completion times, with remaining completion times typically deviating by an average of 20% above or below the range. It can be seen that the majority of actual completion times lie within the predicted upper and lower time bounds. The predicted curves closely follow the actual trend in completion times. It can further be noted that the time taken to provide estimated completion times (inference speed) is relatively fast—averaging about 3 milliseconds to calculate the upper and lower estimates for a single data point on an M2 Max processor. This speed is anticipated, as implementations of the present disclosure execute linear operations in estimating completion times.

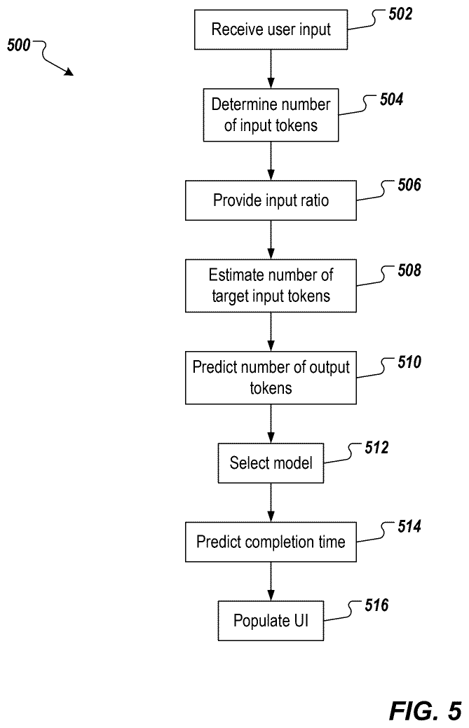

FIG. 5 depicts an example process 500 that can be executed in accordance with implementations of the present disclosure. In some examples, the example process 500 is provided using one or more computer-executable programs executed by one or more computing devices.

User input is received (502). For example, and as described herein with reference to FIG. 2, a user (e.g., the user 112 of FIG. 1) can provide the user input 210 to the LLM-based application 202 through the UI 212 (e.g., displayed on the client device 102 of FIG. 1). The user input 210 can include any appropriate user input (e.g., text, computer-readable file, image, audio). In some examples, the LLM-based application 202 generates a prompt using the user input 210 that is to be processed by the LLM system 204 to return a response. In accordance with implementations of the present disclosure, the LLM-based application 202 sends a request to the completion time estimation system 206 for an estimated completion time. In some examples, the request includes the user input 210 and/or the prompt, a timestamp (e.g., indicating when the user input 210 was received), an identifier of the LLM, and an identifier of the server that executes the LLM.

In some implementations, the completion time estimation system 206 estimates the completion time concurrently with processing of the prompt by the LLM system 204. In some examples, the request is sent to the completion time estimation system 206 before the prompt is sent to the LLM system 204. In some examples, the request is sent to the completion time estimation system 206 after the prompt is sent to the LLM system 204. In some examples, the request is sent to the completion time estimation system 206 at the same time that the prompt is sent to the LLM system 204.

A number of input tokens is determined (504). For example, and as described herein, the completion time estimation system 206 (e.g., the output toke predictor 230) determines a number of input tokens based on the user input 210 and/or the prompt (e.g., as provided in the request). An input ratio is provided (506) and a number of target input tokens is estimated (508). For example, and as described herein, the number of target input tokens is estimated based on the number of input tokens and the input ratio in accordance with Equation 2. In some examples, and as described herein, a lower bound number of target input tokens and an upper bound number of target input tokens can be determined using respective lower bound and upper bound input ratios in accordance with Equations 4 and 5, respectively. A number of output tokens is predicted (510). For example, and as described herein, an output token estimation model is selected by the model selector 234 from a set of output token estimation models stored in the model repository 236. The output token estimation model is specific to the LLM that is being prompted.

A completion time estimation model is selected (512). For example, and as described herein, the model selector 234 selects the completion time estimation model from sets of completion time estimation models stored in the model repository 236. The completion time estimation model is specific to the LLM that is being prompted, the server that executes the LLM, the hour, and the day. An estimated completion time is predicted (514). For example, and as described herein, the number of output tokens is processed through the completion time estimation model to provide the estimated completion time. In some examples, the lower bound number of output tokens and the upper bound number of output tokens are each processed through the completion time estimation model to provide the estimated completion time to include a lower bound estimated completion time and an upper bound estimated completion time.

A UI is populated (516). For example, and as described herein, the estimated completion time is provided to the UI 212 for presentation to the user (e.g., by the completion time estimation system 206, by the LLM-based application 202). For example, a visualization 220 can be provided, which graphically represents the completion time. In some examples, the visualization 220 can be animated to indicate a decreasing estimated completion time as time tolls since the user input 210 was received (e.g., by the LLM-based application 202).

As described herein, implementations of the present disclosure provide multiple advantages in LLM-based applications. For example, for enterprise-level applications, the management of progress and estimation of response times is a critical feature for user experience and interaction quality. In some instances, downstream tasks are dependent on LLM responses. The task of estimating completion times, which directly affect response times, becomes challenging in LLM-based applications due to multiple factors including server speed, network conditions, request demand queues, and the size of the LLMs, among other factors. Particularly in applications with longer waiting times, providing users with an estimated waiting time allows them to manage tasks currently, knowing when to revisit the application. This leads to reduced uncertainty and increased productivity.

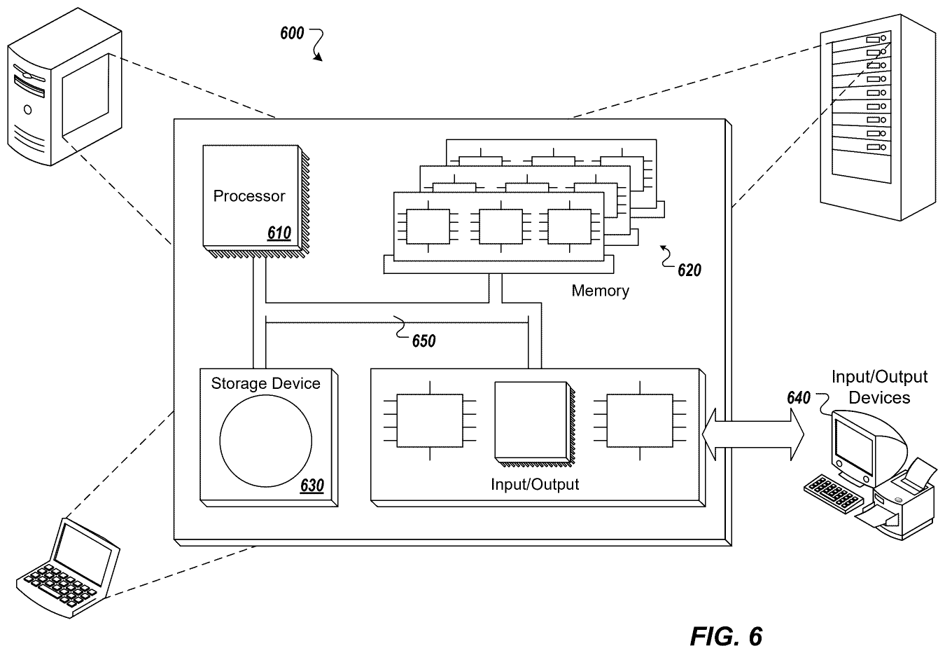

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for estimating completion time of transactions executed using large language models (LLMs), the method being executed by one or more processors and comprising:
receiving a set of tokens representative of user input to a LLM-based application that executes transactions with a LLM;
determining a number of target input tokens based on an input ratio;
predicting a number of output tokens of the LLM using an output token estimation model;
selecting a completion time estimation model from a set of completion time estimation models based on a set of parameters associated with the user input;
generating an estimated completion time by processing the number of output tokens through the completion time estimation model; and
displaying the estimated completion time in a user interface (UI).

2. The method of claim 1, wherein the output token estimation model is specific to the LLM and is selected from a set of output token estimation models.

3. The method of claim 1, wherein the set of completion time estimation models is specific to the LLM and is selected from a plurality of sets of completion time estimation models.

4. The method of claim 3, wherein the set of completion time estimation models is further specific to a server that the LLM is executed on.

5. The method of claim 1, wherein the completion time estimation model is selected from the set of completion time estimation models based on an hour and a day indicated in the set of parameters.

6. The method of claim 1, wherein the estimated completion time comprises a lower bound estimated completion time and an upper bound estimated completion time.

7. The method of claim 1, wherein displaying the estimated completion time in a UI comprises displaying a visualization that graphically represents the estimated completion time and is animated to indicate a decreasing estimated completion time as time tolls since the user input was received.

8. A non-transitory computer-readable storage medium coupled to one or more processors and having instructions stored thereon which, when executed by the one or more processors, cause the one or more processors to perform operations for estimating completion time of transactions executed using large language models (LLMs), the operations comprising:
receiving a set of tokens representative of user input to a LLM-based application that executes transactions with a LLM;
determining a number of target input tokens based on an input ratio;
predicting a number of output tokens of the LLM using an output token estimation model;
selecting a completion time estimation model from a set of completion time estimation models based on a set of parameters associated with the user input;
generating an estimated completion time by processing the number of output tokens through the completion time estimation model; and
displaying the estimated completion time in a user interface (UI).

9. The non-transitory computer-readable storage medium of claim 8, wherein the output token estimation model is specific to the LLM and is selected from a set of output token estimation models.

10. The non-transitory computer-readable storage medium of claim 8, wherein the set of completion time estimation models is specific to the LLM and is selected from a plurality of sets of completion time estimation models.

11. The non-transitory computer-readable storage medium of claim 10, wherein the set of completion time estimation models is further specific to a server that the LLM is executed on.

12. The non-transitory computer-readable storage medium of claim 8, wherein the completion time estimation model is selected from the set of completion time estimation models based on an hour and a day indicated in the set of parameters.

13. The non-transitory computer-readable storage medium of claim 8, wherein the estimated completion time comprises a lower bound estimated completion time and an upper bound estimated completion time.

14. The non-transitory computer-readable storage medium of claim 8, wherein displaying the estimated completion time in a UI comprises displaying a visualization that graphically represents the estimated completion time and is animated to indicate a decreasing estimated completion time as time tolls since the user input was received.

15. A system, comprising:
a computing device; and
a computer-readable storage device coupled to the computing device and having instructions stored thereon which, when executed by the computing device, cause the computing device to perform operations for estimating completion time of transactions executed using large language models (LLMs), the operations comprising:
receiving a set of tokens representative of user input to a LLM-based application that executes transactions with a LLM;
determining a number of target input tokens based on an input ratio;
predicting a number of output tokens of the LLM using an output token estimation model;
selecting a completion time estimation model from a set of completion time estimation models based on a set of parameters associated with the user input;
generating an estimated completion time by processing the number of output tokens through the completion time estimation model; and
displaying the estimated completion time in a user interface (UI).

16. The system of claim 15, wherein the output token estimation model is specific to the LLM and is selected from a set of output token estimation models.

17. The system of claim 15, wherein the set of completion time estimation models is specific to the LLM and is selected from a plurality of sets of completion time estimation models.

18. The system of claim 17, wherein the set of completion time estimation models is further specific to a server that the LLM is executed on.

19. The system of claim 15, wherein the completion time estimation model is selected from the set of completion time estimation models based on an hour and a day indicated in the set of parameters.

20. The system of claim 15, wherein the estimated completion time comprises a lower bound estimated completion time and an upper bound estimated completion time.
